(19) United States
(12) Patent Application Publication
(10) Pub. No.: US 2011/0116859 A1
(43) Pub. Date: May 19, 2011

(54) DEVICE FOR MOUNTING A HYBRID TRANSMISSION ON AN INTERNAL COMBUSTION ENGINE

(75) Inventors: Kai Borntrager, Langenargen (DE); Bernard Hunold, Friedrichshafen (DE); Max Bachmann, Bad Waldsee (DE); Rene Budach, Ravensburg (DE)

(73) Assignee: ZF FRIEDRICHSHAFEN AG, Friedrichshafen (DE)

(21) Appl. No.: 13/002,885

(22) PCT Filed: Jul. 16, 2009
(86) PCT No.: PCT/EP2009/059149

§ 371 Date: Jan. 6, 2011

(30) Foreign Application Priority Data
Jul. 17, 2008 (DE) 10 2008 040 491.8

(51) Int. Cl. F16D 1/08

(52) U.S. Cl. 403/300

(57) ABSTRACT

A device for mounting a hybrid transmission, comprising a transmission unit and a hybrid module, onto an internal combustion engine, namely, for coupling a transmission shaft (10) of the hybrid transmission to a flywheel (13) of the internal combustion engine via a torsion damper (14). The torsion damper (14) can be connected to the transmission shaft (10) by a connecting element (18). The connecting element (18) has a first part (19), with a relatively small diameter, which is clamped to a hub (16) of the torsion damper (14) and a second part (20), with a relatively large diameter, with which, via driving splines (21), the transmission shaft (10) engages.

This application is a National Stage completion of PCT/EP2009/059149 filed Jul. 16, 2009, which claims priority from German patent application serial no., 10 2008 040 491.8 filed Jul. 17, 2008.

### FIELD OF THE INVENTION

The invention concerns a device for mounting a hybrid transmission comprising a transmission unit and a hybrid module onto an internal combustion engine.

### BACKGROUND OF THE INVENTION

The main components of a drivetrain of a motor vehicle are a drive assembly and a transmission unit. The transmission transforms torques and speeds, and thereby converts the traction force produced by the drive assembly into a form that can be used at the wheels of the motor vehicle.

Besides a drive assembly with a fuel-powered or internal combustion engine, a drivetrain with hybrid drive also comprises a hybrid module with an additional drive assembly in the form of an electric motor. The unit consisting of the hybrid module and the transmission is also called a hybrid transmission. The hybrid module and transmission unit has to be mounted on the internal combustion engine using a device for mounting the hybrid transmission on the internal combustion engine.

In solutions known from the prior art, a device for mounting a hybrid transmission on an internal combustion engine comprises a torsion damper by means of which a transmission shaft of the hybrid transmission is coupled to a flywheel of the internal combustion engine. In the devices known from the prior art, the torsion damper is connected directly to the transmission shaft of the hybrid transmission, and to do this a hub of the torsion damper is clamped onto the transmission shaft of the hybrid transmission. But if the diameter of the transmission shaft is relatively large, this connection between the hybrid transmission and the internal combustion engine via a conventional torsion damper presents difficulties.

There is therefore a need for a device for mounting a hybrid transmission onto an internal combustion engine, by virtue of which, when standard torsion dampers are used, the hybrid transmission can be mounted on the internal combustion engine in a simple and space-saving manner even when the transmission shaft of the hybrid transmission has a large diameter.

### SUMMARY OF THE INVENTION

Starting from there the present invention addresses the problem of providing a new type of device for mounting a hybrid transmission comprising a transmission unit and a hybrid module onto an internal combustion engine.

According to the invention, the torsion damper can be connected to the transmission shaft by a connecting element, the connecting element having a first section with a relatively small diameter onto which a hub of the torsion damper can be clamped, and a second section with a relatively large diameter in which the transmission shaft engages via driving splines.

With the device according to the invention for mounting a hybrid transmission on an internal combustion engine, the torsion damper is coupled to the transmission shaft not directly as is usual in the prior art, but indirectly by means of a connecting element. The connecting element has a first section with a relatively small diameter onto which the hub of the torsion damper is clamped. Furthermore, the connecting element has a section with a relatively large diameter to which the transmission shaft can be connected by virtue of driving splines. This makes it possible to use a standard torsion damper for mounting the hybrid transmission on the internal combustion engine, even when the diameter of the transmission shaft is large.

### BRIEF DESCRIPTION OF THE DRAWINGS

Preferred further developments of the invention emerge from the description given below. Example embodiments of the invention, to which it is not limited, are explained in more detail with reference to the drawing, which shows:

FIG. 1: Part of a hybrid module of a hybrid transmission together with a device for mounting the hybrid transmission on an internal combustion engine; and

FIG. 2: The device for mounting a hybrid transmission on an internal combustion engine, shown in isolation

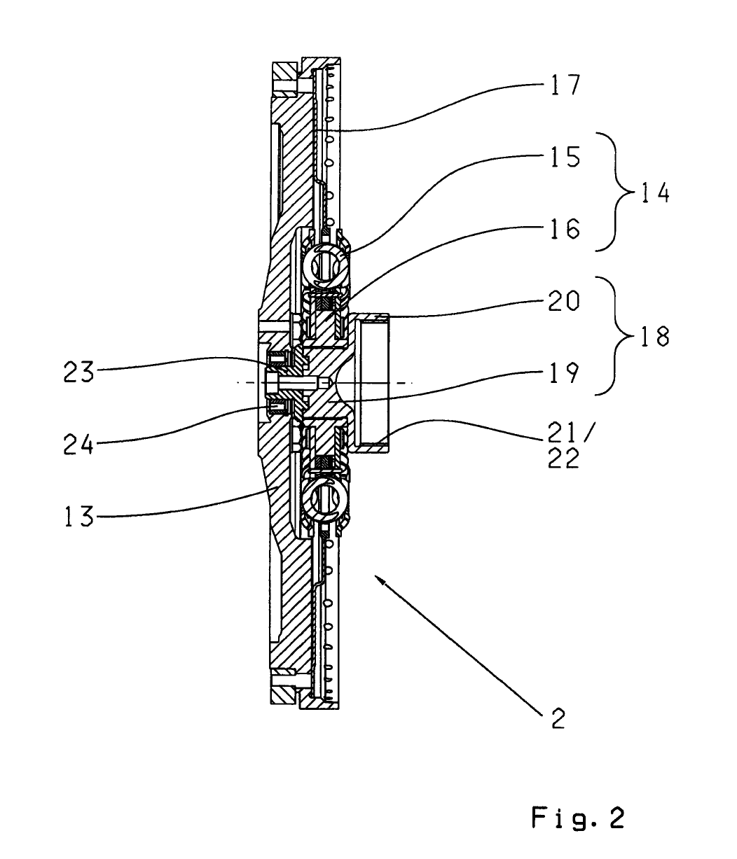

### DETAILED DESCRIPTION OF THE PREFERRED EMBODIMENTS

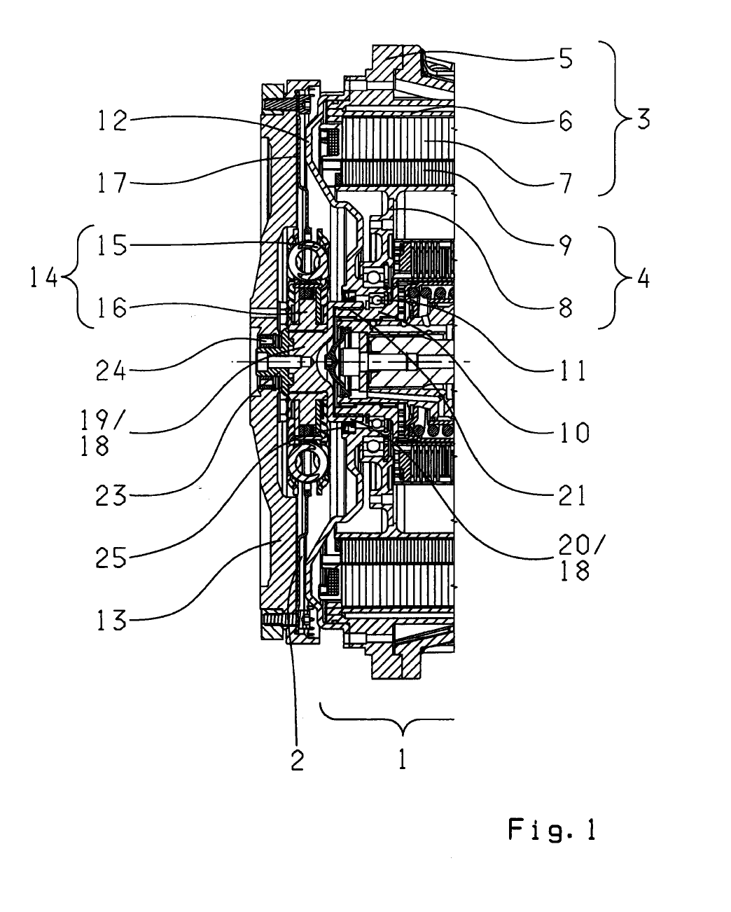

FIG. 1 shows part of a hybrid module 1 of a hybrid transmission together with a device 2 according to the invention for mounting the hybrid transmission on an internal combustion engine. The hybrid module 1 comprises an electric motor, of which FIG. 1 shows the stator portion 3 and the rotor portion 4.

The stator portion 3 comprises a stator housing 5, a stator bush 6 and a stator lamination stack 7. The rotor portion 4 comprises a main rotor body 8 and a rotor lamination stack 9. In addition, the hybrid module 1 of the hybrid transmission comprises a transmission shaft 10 mounted radially by means of a bearing 11 on a housing section 12 of the hybrid module 1.

The device 2 according to the invention for mounting the hybrid transmission by means of its hybrid module 1 onto the internal combustion engine, of which only a flywheel 13 is shown here, comprises a torsion damper 14 with a torsion spring 15 and a hub 16. The torsion damper 14 is connected to the flywheel 13 by a connecting element in the form of a connecting diaphragm 17.

According to the invention, the torsion damper 14 is coupled or connected to the transmission shaft 10 of the hybrid module 1 or hybrid transmission indirectly, by means of a connecting element 18 in the form of a reducing section. The connecting element 18 made as a reducing section has a first part 19 with a relatively small diameter onto which the hub 16 of the torsion damper 14 can be clamped. In addition, the connecting element 18 made as a reducing section has a second part 20 with a relatively large diameter, with which the transmission shaft 10 engages by virtue of driving splines 21 between the connecting element 18 and the transmission shaft 10. The driving splines 21 allow some axial compensation between the hybrid module 1 of the hybrid transmission and the internal combustion engine.

In the example embodiment illustrated, the driving splines 21 are designed such that outer splines on the transmission shaft 10 engage in inner splines 22 of the connecting element 18, the inner splines 22 being formed on the second part 20 of the connecting element 18 made as a reducing section.

To clamp the tension damper 14, namely its hub 16, onto the first part 19 of the connecting element 18 a clamping element 23 is used, which is mounted radially by means of a bearing 24 on the flywheel 13 of the internal combustion engine. The bearing 24, which can also be called a pilot bearing, can also serve as a bearing for the transmission shaft 10.

The driving splines 21 between the connecting element 18 and the transmission shaft 10 are lubricated with oil, and as shown in FIG. 1 the second part 20 of the connecting element 18 is therefore sealed relative to the housing section 12 by a sealing element 25 in order to prevent any outward leakage of oil.

To mount the hybrid transmission on the flywheel of the internal combustion engine, the device according to the invention or more precisely its torsion damper 14 is pre-fitted first, namely on one side on the flywheel 13 by means of the connecting diaphragm 17 and on the other side, by means of the clamping element 23, onto the part 19 of the connecting element 18, and then the hybrid transmission is coupled to the internal combustion engine by coupling the transmission shaft 10 and the connecting element 18 to one another by means of the driving splines 21.

Indexes
Hybrid module
Device
Stator
Rotor
Stator housing
Stator bush
Stator lamination stack
Main rotor body
Rotor lamination stack
Transmission shaft
Bearing
Housing
Flywheel
Torsion damper
Torsion spring
Hub
Connecting diaphragm
Connecting element
First part
Second part
Driving splines
Inner splines
Clamping element
Bearing
Sealing element

1-7. (canceled)

8. A device for mounting a hybrid transmission, comprising a transmission unit and a hybrid module, onto an internal combustion engine for coupling a transmission shaft of the hybrid transmission to a flywheel of the internal combustion engine via a torsion damper,
the torsion damper (14) being connectable to the transmission shaft (10) by a connecting element (18), and
the connecting element (18) having a first part (19), with a relatively small diameter, onto which a hub (16) of the torsion damper (14) being clamped, and having a second part (20), with a relatively large diameter, with which the transmission shaft (10) engages via driving splines (21).

9. The device according to claim 8, wherein the connecting element (18) is a reducing section.

10. The device according to claim 8, wherein the second part (20) of the connecting element (18) has inner splines and the transmission shaft (10) has outer splines which engage with one another to form the driving splines (21).

11. The device according to claim 8, wherein the driving splines (21) allow axial compensation between the hybrid module of the hybrid transmission and the internal combustion engine.

12. The device according to claim 8, wherein the driving splines (21) are lubricated with oil.

13. The device according to claim 8, wherein the torsion damper (14) is clamped onto the first part (19) of the connecting element (18) by a clamping element (23).

14. The device according to claim 13, wherein the clamping element (23) is mounted on the flywheel of the internal combustion engine by a bearing (24).

15. The device according to claim 8, wherein the hub (16) of the torsion damper (14) is clamped onto the first part (19) of the connecting element (18) by a clamping element (23).

16. A device for coupling a hybrid transmission to an internal combustion engine, the device comprising:
a connecting element (18) having a first part (19) and a second part (20) with a diameter of the first part (19) being smaller than a diameter of the second part (20);
the first part (19) of the connecting element (18) being clamped to a hub (16) of a torsion damper (14) coupled to a flywheel of the internal combustion engine;
the second part (20) of the connecting element (18) comprising splines (22) engaging with splines (21) of a transmission shaft (10) of the hybrid transmission, the hybrid transmission comprising a transmission unit and a hybrid module; and
the first part (19) and the second part (20) of the connecting element (18) being integral such that the hybrid transmission couples the internal combustion engine.

17. The device according to claim 16, wherein the connecting element (18) is a cylindrical reducing adaptor.

18. The device according to claim 17, wherein the splines (22) of the second part (20) of the connecting element (18) are located about an inner surface of the connecting element (18) and the splines (21) of the transmission shaft (10) are located about an outer surface of the transmission shaft (10), the splines (22) of the second part (20) of the connecting element (18) engaging the splines (21) of the transmission shaft (10) such that the connecting element (18) is rotationally fixed and axially slidable with respect to the transmission shaft (10) to facilitate axial movement between the hybrid module of the hybrid transmission and the internal combustion engine.

19. The device according to claim 18, wherein the splines (22) of the second part (20) of the connecting element (18) and the splines (21) of the transmission shaft (10) are lubricated with oil.

20. The device according to claim 16, wherein a clamping element (23) clamps the hub (16) of the torsion damper (14) to the first part (19) of the connecting element (18).

21. The device according to claim 19, wherein the flywheel (13) of the internal combustion engine is rotatably supported, via a bearing (24), on the clamping element (23).
